(19) United States
(12) Patent Application Publication
(10) Pub. No.: US 2013/0082909 A1
(43) Pub. Date: Apr. 4, 2013

(54) DISPLAY APPARATUS

(71) Applicants: Seishi Miura, Mobara-shi (JP); Koji Ishizuya, Chiba-shi (JP)

(72) Inventors: Seishi Miura, Mobara-shi (JP); Koji Ishizuya, Chiba-shi (JP)

(73) Assignee: CANON KABUSHIKI KAISHA, Tokyo (JP)

(21) Appl. No.: 13/600,379

(22) Filed: Aug. 31, 2012

(30) Foreign Application Priority Data
Sep. 29, 2011 (JP) 2011-214141

(51) Int. Cl. G09G 3/30

(52) U.S. Cl. 345/76

(57) ABSTRACT

A display apparatus includes a plurality of subpixels having different emission colors in a pixel, and each of the subpixels includes an organic EL device. A high-refractive-index transparent layer having a refractive index higher than that of an organic compound layer of the organic EL device is provided on a light exit side of the organic EL device, and further, a light extraction structure is arranged on an outer circumference of the subpixel on the light exit side of the high-refractive-index transparent layer. A distance between first electrodes of the subpixels closest to each other, which are respectively included in the two adjacent pixels, is set to be larger than that between the first electrodes of the two adjacent subpixels within the pixel.

### BACKGROUND OF THE INVENTION

1. Field of the Invention

The present invention relates to a display apparatus including an organic electroluminescence (EL) device, and more particularly, to a full-color display apparatus in which one pixel includes a plurality of subpixels having different emission colors.

2. Description of the Related Art

In recent years, organic light-emitting devices that emit light spontaneously with a low drive voltage of about several volts are drawing attention. Due to excellent features such as surface emitting characteristics, light weight, and visibility, the organic electroluminescence (EL) device is being put into practical use as a light-emitting apparatus of a thin display, lighting equipment, a head-mounted display, or a light source for a printhead of an electrophotographic printer.

The organic EL device has structure in which an emission layer made of an organic material and a plurality of layers made of organic materials having separated functions are sandwiched between an anode and a cathode, and an electrode on at least one light exit side is transparent. Due to this stacked structure, light traveling in a direction at a critical angle or larger in each interface determined by a refractive index of the emission layer, a medium on the light exit side, and a refractive index of air into which light is finally released is totally reflected to be confined as propagating light in the device. The propagating light is absorbed by organic compound layers and metal electrodes in the device and is not extracted out of the device, with the result that light extraction efficiency is lowered.

For improving the light extraction efficiency, there have been proposed a number of methods of changing a traveling direction of light to break the total reflection condition, such as a method of providing fine uneven structure or lens structure on the surface on the light exit side so as to extract the propagating light out of the device. In particular, as a method having high improvement effects, there has been proposed a method of providing a transparent layer, the refractive index of which is equal to or higher than that of an emission layer, adjacently to a light exit side of a transparent electrode, and further providing a region for causing disturbance in reflection/scattering angles of light on the light exit side of the transparent layer or in the transparent layer (see Japanese Patent Application Laid-Open No. 2004-296429).

According to the above-mentioned method, based on the classical Snell's law, propagating light in the emission layer which occupies about 80% of the light emitted by the emission layer is pulled in a high-refractive-index transparent layer whose refractive index is higher than that of the emission layer to be converted into propagating light in the transparent layer. The propagating light thus obtained is extracted out of the device through the region for causing disturbance in reflection/scattering angles of light on the surface of the transparent layer or in the transparent layer.

However, when the method of causing light to propagate through the high-refractive-index transparent layer is applied to a display apparatus such as a display, a peculiar problem occurs. Light which is guided to the high-refractive-index transparent layer and is finally output to the air through the region for causing disturbance in reflection/scattering angles of light includes light traveling at an angle equal to or higher than a critical angle, which is originally supposed to be totally reflected. This light is recognized as light emitted from a position different from an actual light-emitting point due to parallax caused by the thickness of the high-refractive-index transparent layer, and hence, there arises a problem of blur in a display image. In order to solve this problem, there has been proposed a method of adjusting the thickness of a substrate (although not the high-refractive-index transparent layer), through which light propagates, to a predetermined proportion or less of a pixel size (see Japanese Patent Application Laid-Open No. 2005-322490).

Further, when the light guided to the high-refractive-index transparent layer enters the region for causing disturbance in reflection/scattering angles, the light is not necessarily extracted to an air side through one incidence. Light whose traveling direction has been changed by the region for causing disturbance in reflection/scattering angles is also totally reflected again to propagate through the high-refractive-index transparent layer in the case where the light travels at an angle equal to or larger than a critical angle in an interface between the high-refractive-index transparent layer and the air. Consequently, the light propagates laterally through the high-refractive-index transparent layer and is eventually output to the air side at a position away from the light-emitting point at which the total reflection condition has been broken. Therefore, there still arises a problem of blur in a display image. In particular, as the refractive index of the transparent layer is higher, the amount of high-angle component light is larger, and hence, the number of times at which the light enters the region for causing disturbance in reflection/scattering angles decreases, and the waveguide length in the lateral direction up to the point where the light is extracted to the air side increases, which renders the problem more serious.

On the other hand, in the case of providing means for preventing the waveguide length of light from increasing between subpixels so as to suppress the above-mentioned problem, there has been a problem in that light extraction efficiency itself is degraded.

### SUMMARY OF THE INVENTION

It is an object of the present invention to provide a display apparatus using an organic electroluminescence (EL) device which is capable of efficiently extracting, out of the device, propagating light which propagates through a transparent layer having a refractive index higher than that of an organic compound layer, to thereby reduce blur in a display image.

The present inventors have paid attention to the fact that, in a display apparatus using an organic EL device, light which propagates laterally through a transparent layer is generated when being repeatedly reflected between a region for causing disturbance in a reflection/scattering angle and a reflective layer so as to cause blur in an image, and have therefore accomplished the present invention.

That is, according to an exemplary embodiment of the present invention, there is provided a display apparatus, including a plurality of pixels each including a plurality of subpixels having different emission colors, each of the plurality of subpixels including an organic electroluminescence device which includes: a first electrode that is a reflective electrode; a second electrode; and an organic compound layer including an emission layer disposed between the first electrode and the second electrode, in which the display apparatus further includes a transparent layer having a refractive index higher than a refractive index of the organic compound layer, the transparent layer being arranged on a light exit side of the organic electroluminescence device, in which the transparent layer includes a light extraction structure provided on an outer side of each of the plurality of subpixels, and in which a distance between the first electrodes of subpixels closest to each other, which are respectively included in adjacent two of the plurality of pixels, is larger than a distance between the first electrodes of adjacent two of the plurality of subpixels within each of the plurality of pixels.

According to the present invention, it is possible to provide the display apparatus in which the blur in the display image is reduced while the light extraction efficiency is enhanced.

Further features of the present invention will become apparent from the following description of exemplary embodiments with reference to the attached drawings.

### BRIEF DESCRIPTION OF THE DRAWINGS

FIG. 1A is a schematic cross-sectional view illustrating a configuration of a display apparatus according to an exemplary embodiment of the present invention.

FIG. 1B is a schematic cross-sectional view illustrating a configuration of an organic EL device used in the display apparatus according to the exemplary embodiment of the present invention.

FIG. 2 is a schematic view illustrating a planar arrangement and a cross-section of a light extraction structure in the display apparatus according to the present invention.

FIG. 3 is a schematic view illustrating a state of reflection of light which travels to an adjacent subpixel provided in an inter-subpixel region within a pixel of the display apparatus according to the present invention.

FIG. 4 is a schematic view illustrating a state of reflection of light which travels to an adjacent subpixel provided in an inter-subpixel region between pixels of the display apparatus according to the present invention.

FIG. 5 is a schematic view illustrating a planar arrangement of a first electrode and a light extraction structure of a display apparatus according to Example 1 of the present invention.

FIG. 6 is a schematic view illustrating a planar arrangement of a first electrode and a light extraction structure of a display apparatus according to Comparative Example 1 of the present invention.

FIG. 7 is a schematic view illustrating a planar layout in which subpixels are delta-arranged in the display apparatus according to the present invention.

FIG. 8 is a graph showing a radiation intensity distribution of an organic EL device in a transparent layer under a 3λ/4 interference condition.

FIG. 9 is an explanatory diagram of a condition for suppressing propagation of propagating light to an adjacent pixel.

### DESCRIPTION OF THE EMBODIMENTS

A display apparatus of the present invention includes a plurality of pixels each including a plurality of subpixels having different emission colors, and each subpixel includes an organic electroluminescence (EL) device. The organic EL device includes a first electrode, a plurality of organic compound layers including an emission layer having a light-emitting region provided on the first electrode, and a second electrode. The organic EL device emits light through use of energy generated by the recombination of holes and electrons which are injected into the organic compound layers by the application of a voltage across the first and second electrodes. In the present invention, the first electrode is a reflective electrode, and the second electrode is a transparent electrode. Further, one of the first electrode and the second electrode is an anode and the other thereof is a cathode. In the display apparatus of the present invention, the reflective electrode is formed as the first electrode on a support substrate, and emitted light is extracted from the transparent electrode side. In the display apparatus of the present invention, in order to effectively extract light emitted in the organic EL device outside, a high-refractive-index transparent layer having a refractive index higher than those of the organic compound layers is provided adjacently to the transparent electrode. Further, a light extraction structure for extracting the light is arranged adjacently to the high-refractive-index transparent layer. This configuration enables a large part of light from the emission layer to reach the light extraction structure without being totally reflected, and to be effectively extracted outside.

In the present invention, in order to suppress a problem of blur on a display, the distance between reflective electrodes in an inter-pixel region is set to be larger than that between reflective electrodes in a pixel. Thus, blur in a display image caused by color mixing in the inter-pixel region can be suppressed.

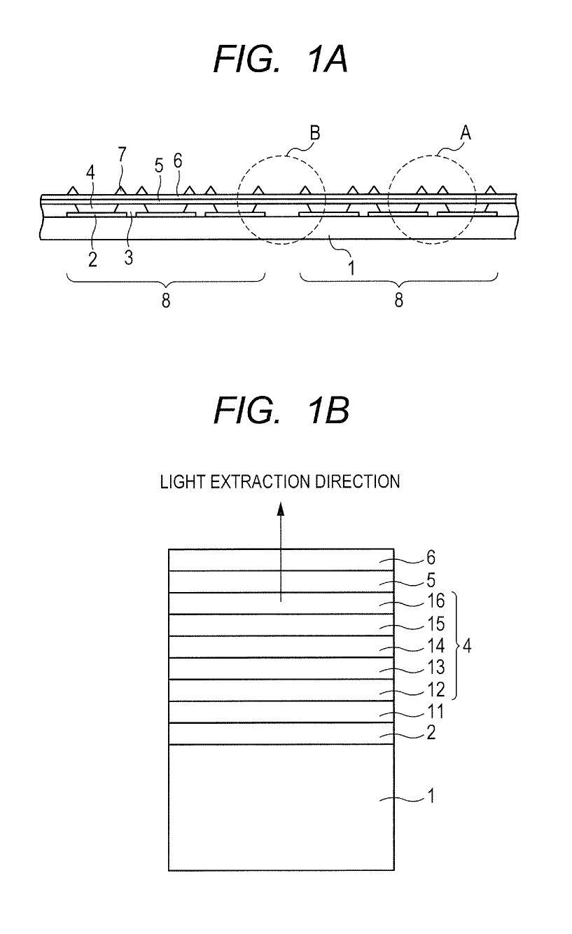

Hereinafter, an embodiment of the present invention is described. FIG. 1A is a schematic cross-sectional view of a display apparatus according to the embodiment of the present invention. In the present embodiment, three subpixels respectively emitting light of three primary colors (blue, green, and red) in a horizontal direction of the drawing sheet of FIG. 1A constitute one pixel 8. Note that, in the configuration of FIG. 1A, although a bank 3 is provided so as to avoid inter-pixel crosstalks, a short circuit, and the disconnection of electrode wiring or to insulate a region between electrodes to limit a light-emitting region, the bank 3 may not be provided. Further, in the display apparatus of the present invention, a light-emitting region of each subpixel is determined by the area of a patterned reflective electrode 2 formed on a support substrate 1 (described later). In the case where the bank 3 is provided, an opening portion of the bank 3 defines the light-emitting region, and a subpixel region in the present invention is defined by the light-emitting region.

The subpixels are formed of organic EL devices having respective emission colors. In FIG. 1A, each organic EL device includes the reflective electrode 2 as the first electrode on the support substrate 1 and an organic compound layer 4 on the reflective electrode 2, and further, includes a transparent electrode 5 as the second electrode on a light exit side. The organic compound layer 4 includes an emission layer for emitting light according to the emission color of each of the subpixels. The transparent electrode 5 is formed continuously over the entire display region and has, on a light exit side thereof (side opposite to the support substrate 1 side), a high-refractive-index transparent layer 6 having a refractive index higher than that of the organic compound layer 4. Further, the high-refractive-index transparent layer 6 includes a light extraction structure 7 on the light exit side thereof.

FIG. 1B illustrates a configuration example of the cross-sectional structure of the organic EL device used in each of the subpixels. It is well known that a plurality of organic compound layers including an emission layer are present between the reflective electrode 2 and a transparent electrode 11 as the first electrode provided on the support substrate 1 and the transparent electrode 5 as the second electrode, and various stack configurations may be contemplated from viewpoints of emission efficiency, a driving lifetime, and optical interference. Note that, although only the reflective electrode 2 is illustrated as the first electrode in FIG. 1A, the first electrode is formed of the reflective electrode 2 and the transparent electrode 11 in the configuration of FIG. 1B, and any configuration may be applied to the present invention as long as the configuration is an electrode configuration having reflectivity.

FIG. 1B illustrates an exemplary configuration in which a hole injection layer 12, a hole transport layer 13, an emission layer 14, an electron transport layer 15, and an electron injection layer 16 are provided as the organic compound layer 4. The present invention has no limitation on materials contained in each layer. For example, any one of a fluorescent material and a phosphorescent material can be used as a material constituting the emission layer 14, and at least one kind of compounds may be contained in the emission layer 14 in addition to a host material and a light-emitting material so as to enhance device performance. Further, the hole transport layer 13 may function as an electron blocking layer, and the electron transport layer 15 may function as a hole blocking layer.

By adjusting the film thickness between a light-emitting position of the emission layer 14 and a reflective surface of the reflective electrode 2 of the organic compound layer 4, a light radiation distribution in the emission layer 14 can be controlled. In a display apparatus, by setting the film thickness of each organic compound layer so that the luminance becomes high particularly in the front direction, an emission color is also controlled by optical interference, and light is radiated in the front direction more efficiently.

Specifically, by adjusting the optical distance from the light-emitting position of the emission layer 14 to an interface between the transparent electrode 11 and the reflective electrode 2 to be n/4 (n=1, 3, 5, . . . ) of an emission wavelength, front luminance in the light extraction direction from the emission layer 14 can be further enhanced. Note that, the front luminance of the entire organic compound layer 4 is usually 150 nm to 350 nm.

In order to enhance the light extraction efficiency, it is preferred that the reflectivity of the reflective electrode 2 be higher. For example, as a material for the reflective electrode 2, a silver (Ag) electrode is more preferred than an aluminum (Al) electrode. As means for further enhancing the reflectivity, a procedure for stacking layers having different refractive indices as in a dielectric multi-layered film mirror may be used.

In the example of FIGS. 1A and 1B, emitted light is not confined in the device through use of the transparent electrode 5 as the second electrode, but light is extracted to the light extraction structure 7 without being confined or totally reflected by providing the high-refractive-index transparent layer 6 on the light exit side of the transparent electrode 5. Specifically, the total reflection occurring between the high-refractive-index transparent layer 6 and the air or another medium is avoided by providing the light extraction structure 7, and light in the device can be effectively extracted outside. Thus, the light extraction efficiency of the organic EL device, which is usually considered to be about 20%, is enhanced remarkably.

Further, a translucent electrode may be used in place of the transparent electrode 5 of the second electrode. In this case, the reflectivity of the second electrode increases, with the result that the characteristics as an optical resonator are exhibited. However, a high-angle radiation optical component from the emission layer 14 is generated to some degree. Therefore, it may also be effective to use the translucent electrode even though an increase in the light extraction efficiency through use of the translucent electrode is smaller than that obtained by using the transparent electrode 5. This means that the effect does not particularly depend on whether or not the second electrode is transparent.

The high-refractive-index transparent layer 6 may be used as a barrier layer against the intrusion of gas such as water vapor or oxygen. In order for the high-refractive-index transparent layer 6 to function as a barrier layer, the film thickness thereof may be about several μm, although it depends on a material to be used. The preferred film thickness also depends on the size of the light extraction structure 7, and hence, the film thickness does not need to be defined. It is not preferred that the film thickness of the high-refractive-index transparent layer 6 be large, because light easily propagates for a long distance in the high-refractive-index transparent layer 6, and the light is easily extracted from the light extraction structure 7 on an adjacent pixel 8. The film thickness of the high-refractive-index transparent layer 6 is more preferably 0.5 μm or more and 10.0 μm or less from a viewpoint of the enhancement of the light extraction efficiency.

Although the refractive index of the organic compound layer 4 varies depending on the material, the refractive index thereof is generally about 1.6 to 2.0 in a blue light-emitting region, about 1.5 to 1.9 in a green light-emitting region, and about 1.5 to 1.8 in a red light-emitting region. Thus, the high-refractive-index transparent layer 6 only needs to have a refractive index at least higher than those of the organic compound layers 4 used in the organic EL devices in the respective blue, green, and red light-emitting regions.

Further, as a material for the high-refractive-index transparent layer 6, titanium oxide, zirconium oxide, and zinc oxide can be used. However, it is difficult to process those materials. In the present invention, it is preferred that the high-refractive-index transparent layer 6 be formed of a silicon nitride (SiNₓ) film or the like. No particular limitation is imposed on the element composition and element compositional ratio of the silicon nitride (SiNₓ) film, and other elements may be mixed with nitrogen and silicon as main components. As a film formation process for obtaining the silicon nitride film, chemical vapor deposition (CVD) is used. Although the optical constant of the silicon nitride film also varies depending on the film formation conditions such as a substrate temperature and a film formation speed, the silicon nitride film only needs to be a transparent layer having a refractive index higher than that of the organic compound layer 4 in the present invention. The light transmittance of the high-refractive-index transparent layer 6 is preferably 85% or more, more preferably 90% or more in a visible light region.

It is preferred that the light extraction structure 7 according to the present invention be formed by directly processing the high-refractive-index transparent layer 6, and the difference in refractive index between the high-refractive-index transparent layer 6 and the light extraction structure 7 be eliminated.

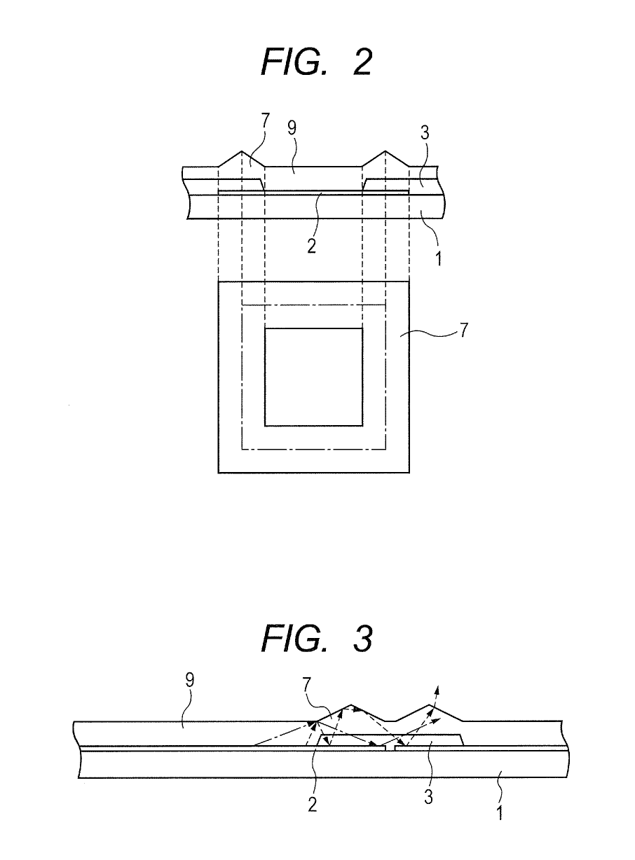

As the light extraction structure 7, for example, a pyramid-shaped, conical, or mesa-type prism, lens, diffraction grating, or the like is used. More preferably, as illustrated in FIG. 2, an extraction structure having a triangular cross-section is arranged so as to surround a subpixel. In particular, it has been found that a light extraction structure having a triangular cross-section with an apex angle of about 120° to 140° allows extracted light to travel to the front surface, and hence, is more effective for enhancing the front luminance of the device. Note that, in FIG. 2 and FIGS. 3 and 4 (described later), for convenience sake, the transparent electrode 11, the organic compound layer 4, the transparent electrode 5, and the high-refractive-index transparent layer 6, which are formed on the light exit side with respect to the reflective electrode 2, are illustrated as a transparent layer 9.

In the present invention, the light extraction structure 7 is provided so as to surround an outer circumference of each subpixel. Preferably, the light extraction structure 7 is formed in such a manner that the end of the reflective electrode 2 of the subpixel and the outermost circumference of the light extraction structure 7 are matched with each other on a plane. The light extraction structure 7 may have a configuration in which a plurality of conical structures surround an outer circumference of each light-emitting region (subpixel) or in which one ring-shaped structure in which conical structures are integrated in a loop shape surrounds singly an outer circumference of the light-emitting region (subpixel).

No particular limitation is imposed on a method of producing the light extraction structure 7. For example, a resist pattern is formed on a film of SiNₓ or the like by photolithography, and after that, the resist pattern is subjected to dry etching to form intended structure. Alternatively, an intended mold pattern is transferred onto SiNₓ by nanoimprinting, and after that, SiNₓ is processed by dry etching.

When the light extraction structure 7 is provided on the inter-subpixel region, light emitted from the subpixels adjacent to the inter-subpixel region enters the inter-subpixel region to be extracted. However, color mixing caused by the light extraction structure 7 in the pixel 8, for example, color mixing among blue, green, and red is additive color mixing of gradation-controlled colors, and hence, has no effect on the control for obtaining intended chromaticity. The color mixing rather has an advantage in that light propagating to the adjacent subpixels can be extracted, and hence, the light extraction efficiency is enhanced.

On the other hand, emission colors from the subpixels, which are separately controlled for gradation, are to be mixed from the light extraction structure 7 provided on the inter-pixel region. For example, color mixing of a red subpixel and a blue subpixel which are included in the different pixels 8 and are adjacent to each other with the inter-pixel region interposed therebetween ends up becoming additive color mixing which is not intended, because the gradation control of each subpixel is not matched with an emission color intended to be extracted. Thus, light of the unintended additive color mixing is extracted.

In the present invention, the distance between the reflective electrodes 2 of the closest subpixels, which are included respectively in adjacent two pixels, is set to be larger than the distance between the subpixels within the pixel 8, that is, the distance between the reflective electrodes 2 of the two subpixels adjacent to each other. With such a configuration, the light extraction efficiency can be enhanced while blur in an image is suppressed.

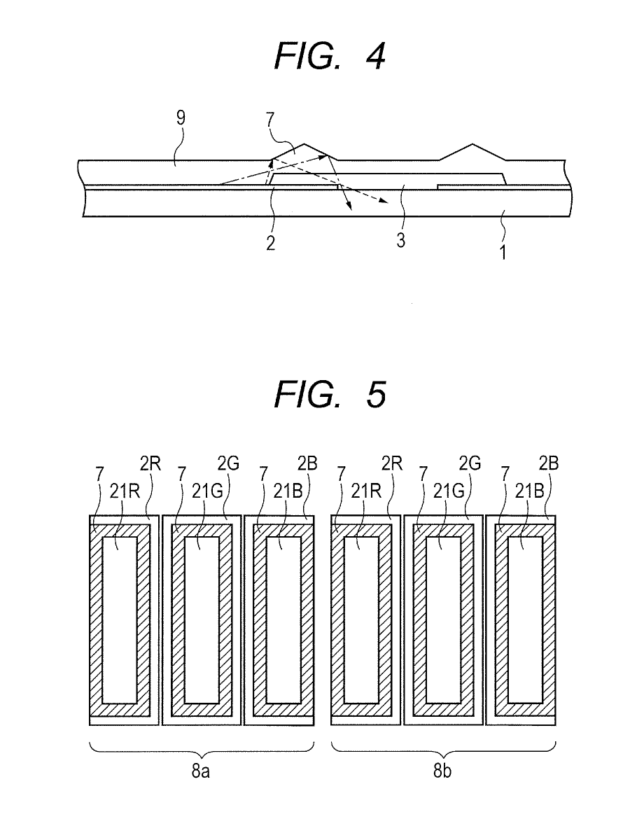

This point is described in detail with reference to FIGS. 3 and 4. FIGS. 3 and 4 are respectively enlarged schematic views of portions A and B of FIG. 1A, and schematically illustrate a state in which light propagates between the subpixels adjacent to each other.

In an inter-subpixel region between the subpixels adjacent to each other within a single pixel as illustrated in FIG. 3, the distance between the reflective electrodes 2 is set to be small. In this case, most of light which has traveled to the adjacent subpixel is extracted outside after traveling and being repeatedly reflected in the transparent layer 9 provided between the reflective electrode 2 and the light extraction structure 7. Thus, in the case of such a structure, emitted light can be extracted through use of the light extraction structure 7 of the adjacent subpixel, to thereby enhance the light extraction efficiency. Further, as described above, the distance between the subpixels is set to be small within the pixel, which does not lead to blur in an image.

On the other hand, as illustrated in FIG. 4, the distance between the reflective electrodes 2 of the subpixels adjacent to each other, which are respectively included in the pixels adjacent to each other, is set to be large. In this case, the light which has propagated to the subpixel of the adjacent pixel is mostly guided to the support substrate 1 side due to the absence of the reflective electrode 2 in the inter-subpixel region, and therefore is not extracted outside. Accordingly, the light emitted from the pixel is not extracted from the adjacent pixel, which can suppress blur in an image.

Specifically, a region having no reflective electrode 2 is set to be small so that light propagating to the adjacent subpixel within the pixel is reflected to the light exit side as much as possible, and a region having no reflective electrode 2 is set to be large so that light propagating outside the pixel is not reflected to the light exit side in the inter-pixel region.

Next, the effect of placing the light extraction structure around the pixel is described. As described above, of the light emitted within the subpixel, light which is totally reflected at an interface between the transparent layer and the air is repeatedly reflected between the reflective electrode 2 and the air interface to travel to an end of the subpixel. The light having travelled to the end of the subpixel is extracted outside with its angle changed by the multiple reflections by the light extraction structure 7 disposed at the end of the subpixel and the reflective electrode 2 disposed below the light extraction structure 7. Specifically, in order to change the angle of the light by the light extraction structure 7, it is necessary that the reflective electrode be present and disposed below the light extraction structure 7.

On the other hand, in the case where the reflective electrode 2 is present, light that has not been extracted from the light extraction structure 7 is repeatedly reflected at the air interface to be extracted from the adjacent pixel. Thus, in order to prevent the light from propagating to the adjacent pixel, it is preferred not to form the reflective electrode 2 in the inter-pixel region.

Specifically, in order to enhance the light extraction efficiency while preventing light leakage to the adjacent pixel, it is preferred that the outer circumferential end of the light extraction structure 7 and the outer circumferential end of the reflective electrode 2 be disposed so as to be substantially matched with each other in a planar arrangement.

Note that, the above-mentioned effect can also be obtained from a delta-shaped pixel arrangement as illustrated in FIG. 7 or a four-color pixel arrangement, as well as from the stripe-shaped pixel arrangement, and hence, no limitation is imposed on the pixel arrangement.

Next, the thickness of the transparent layer 9 (transparent electrode 11, organic compound layer 4, transparent electrode 5, high-refractive-index transparent layer 6) and the inter-subpixel distance (distance between the reflective electrodes 2 adjacent to each other) are described.

In the case where propagating light travels while being repeatedly reflected between the light extraction structure 7 and the reflective electrode 2 as described above, as the film thickness between the reflective electrode 2 and the light extraction structure 7, that is, the film thickness of the transparent layer 9 is larger, the distance through which the propagating light travels in one reciprocating movement becomes larger. Thus, in the case where the film thickness of the transparent layer 9 is large, the inter-subpixel distance in the inter-pixel region is also preferred to be set large.

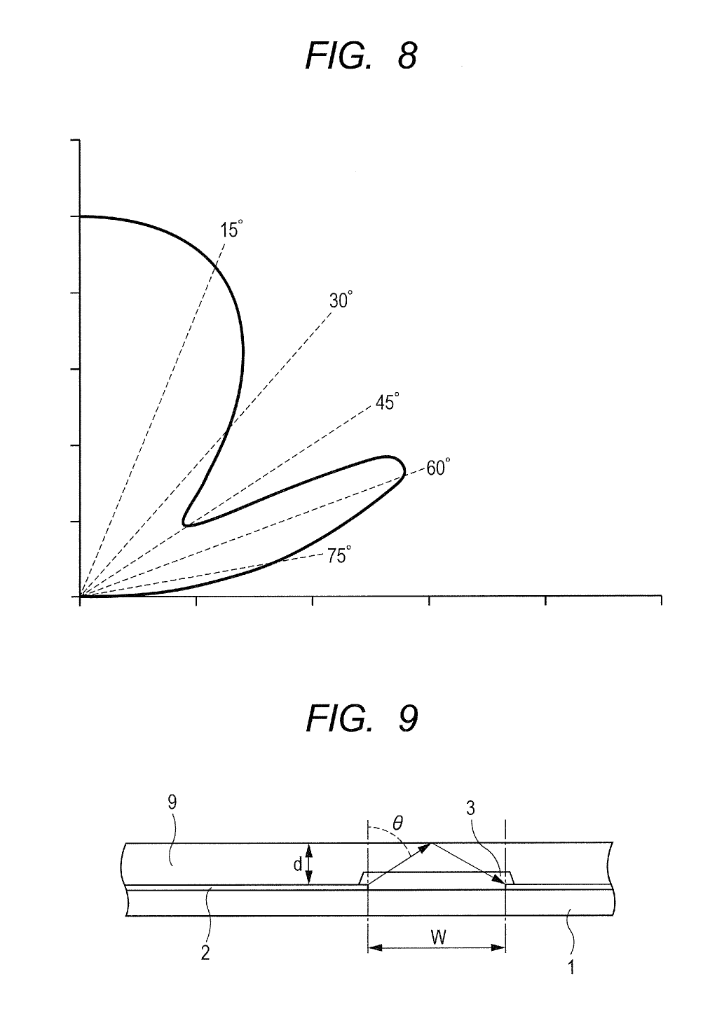

In general, it is known that the interference condition under which the radiation intensity of the front surface of an organic EL device is maximized is to set the optical film thickness of the light-emitting region and the reflective electrode 2 to be an odd multiple of λ/4 (λ: emission wavelength). It is known that the radiation intensity distribution of the organic EL device in the transparent layer 9 varies depending upon the interference condition. For example, in the case where the interference condition of the light-emitting region and the reflective layer is set to be 3λ/4, a radiation intensity distribution as shown in FIG. 8 is obtained. Specifically, there is a first-order maximum in the front direction, and there is a maximum of the radiation intensity also in the vicinity of 60° on a high-angle side. This radiation light mainly becomes a propagating component, and hence, in order to suppress the extraction of propagating light from the adjacent pixel, it is necessary to suppress the propagation of light which is repeatedly reflected at least at that angle.

As illustrated in FIG. 9, in order to suppress the propagation of light between the pixels adjacent to each other, the following condition is preferred. That is, it is preferred that a relationship: tan θ<W/2d be satisfied, where θ represents an angle formed by a normal to the substrate and, in the radiation intensity distribution of the organic EL device in the transparent layer 9, a direction in which a maximum of the radiation intensity appears, the direction excluding a front radiation direction (direction of the normal to the substrate), d represents a distance from the reflective electrode 2 to a light exit surface of the high-refractive-index transparent layer 6, and W represents a distance between the reflective electrodes adjacent to each other. Note that, in FIG. 9, for convenience sake, the light extraction structure 7 to be formed on the transparent layer 9 is not illustrated. In the case where the high-refractive-index transparent layer 6 and the light extraction structure 7 are formed integrally, the position of the light exit surface of the light extraction structure 7 closest to the support substrate 1 corresponds to the light exit surface of the high-refractive-index transparent layer 6.

The opening shape of the subpixel (opening shape of the bank 3) is not limited to a rectangular shape and may be a circular shape. In the case where the opening shape is a circular shape, for example, light is radiated isotropically and three-dimensionally, and hence, the light extraction structure 7 can be effectively disposed with respect to the circular opening.

Note that, arrangements and characteristics of a circuit, wiring, and a thin film transistor (TFT) to be used for driving the display apparatus of the present invention are not particularly defined, and may be designed and provided, as needed, for obtaining intended performance.

Further, in the display apparatus of the present invention, the light extraction structure is used for extracting light confined in the device outside, and the light extraction structure may be further sealed with sealing glass such as a glass cap or sheet glass. A color filter for improving chromaticity and a circularly polarizing plate for reducing the reflection of ambient light may be provided on the sealing glass.

### EXAMPLES

### Example 1

In Example 1, a display apparatus, which included an organic EL device having the cross-sectional structure of FIG. 1B, in which subpixels were partitioned by banks 3 as illustrated in FIG. 1A, and in which the subpixels and pixels were arranged as illustrated in FIG. 5, was produced by the following method. Note that, in FIG. 5, openings (light-emitting regions) 21R, 21G, and 21B are respectively provided in a red subpixel, a green subpixel, and a blue subpixel, and each subpixel is formed of the organic EL device. In addition, reflective electrodes 2R, 2G, and 2B are respectively provided in the red subpixel, the green subpixel, and the blue subpixel, and there are provided pixels 8a and 8b.

First, a TFT drive circuit (not shown) made of low-temperature polysilicon was formed on a glass substrate as a support, and a flattening film (not shown) made of an acrylic resin was formed on the TFT drive circuit to obtain a support substrate 1. Next, as a reflective electrode 2, an Ag alloy was formed on the support substrate 1 by sputtering so as to have a film thickness of about 150 nm. The reflective electrode 2 made of an Ag alloy was a highly reflective film having a spectral reflectivity of 80% or more in a visible light wavelength region (λ=380 nm to 780 nm). Further, a film of indium tin oxide (ITO) having a thickness of 50 nm was formed as a transparent electrode 11 by sputtering. After that, a polyimide-based resin was spin-coated as the bank 3, and the openings 21R, 21G, and 21B were respectively provided in intended subpixels by photolithography.

After that, respective organic compound layers 4 were successively formed and stacked by vacuum deposition. The thickness of each organic compound layer 4 was 200 nm. In the display apparatus of the present example, for each emission color, the film thickness of a hole transport layer 13 was changed so that the optical film thickness from an emission layer 14 to the reflective electrode 2 corresponded to ¾ of each emission color wavelength. Regarding a blue color, a fluorescent material was used as a light-emitting dopant in the emission layer, and regarding green and red colors, a phosphorescent material, which was expected to exhibit higher internal quantum efficiency, was used as the light-emitting dopant in the emission layer. The refractive index of a layer having the highest refractive index in the organic compound layers of each subpixel was 1.86 in the blue subpixel, 1.80 in the green subpixel, and 1.78 in the red subpixel.

Next, a film of indium zinc oxide (IZO) was formed to have a thickness of 4 μm as a transparent electrode 5 by sputtering. Then, as a high-refractive-index transparent layer 6, a silicon nitride (SiN) film was formed by CVD. The refractive index of the SiN film was 1.89 in a wavelength of 450 nm, 1.88 in a wavelength of 520 nm, and 1.86 in a wavelength of 620 nm. Thus, the refractive index in any subpixel was higher than that of the organic compound layer 4.

Hexamethyldisilazane was spin-coated on the SiN film to modify the surface, and thereafter, a photoresist (AZ1500) was spin-coated to obtain a film having a film thickness of about 2.5 μm. The photoresist was exposed to light, through use of a mask aligner (MPA-600FA), with a photomask corresponding to a light extraction structure 7 of FIG. 5. Then, the exposed photoresist was developed with a developer (AZ312MIF) to obtain a resist pattern. Post-baking was conducted on the developed photoresist at 120° C. for 3 minutes to reflow a resist shape. The SiN film was etched together with the resist pattern by dry etching using carbon tetrafluoride and oxygen, to thereby process the SiN film into the light extraction structure 7 so as to surround the subpixel. At this time, the film thickness of the high-refractive-index transparent layer 6 having a refractive index higher than that of the organic compound layer 4 was 1.0 μm, and the light extraction structure 7 had a cross-section close to an isosceles triangle with a height of 2.3 μm, a width of 10 μm, and an apex angle of about 130°.

Here, the planar arrangement of the light extraction structure 7 was as illustrated in FIG. 5. Specifically, in an inter-subpixel region within the pixel, the reflective electrode 2 was formed up to the outer sides of the light extraction structure 7, whereas in an inter-subpixel region between the pixels, an outer circumferential end of the reflective electrode 2 and an outer circumferential end of the light extraction structure 7 were disposed so as to be matched with each other.

By the way, when the light extraction structure 7 is provided on an inter-subpixel region, the emission colors from the subpixels adjacent to each other enter each other to be extracted. However, color mixing caused by the light extraction structure within a pixel region, for example, color mixing among red, green, and blue is additive color mixing of gradation-controlled colors, and hence, has no effect on the control for obtaining intended chromaticity.

On the other hand, the emission colors from the subpixels, which are separately controlled for gradation, are mixed with each other from the light extraction structure provided on an inter-pixel region. For example, color mixing caused when a red subpixel in a first pixel region is adjacent to a blue subpixel in a second pixel region adjacent to the first pixel ends up becoming unintended additive color mixing because the gradation control for respective subpixels is not synchronized to each other. Thus, light of the unintended additive color mixing is extracted.

In the pixel layout as illustrated in FIG. 5, for example, the pixels 8a and 8b are discussed. The reflective electrodes 2R, 2G, and 2B correspond to the respective red, green, and blue subpixels belonging to the pixel 8a. In regions between the reflective electrodes 2R and 2G and between the reflective electrodes 2G and 2B, which were included within the pixel 8a, each reflective electrode was formed up to the outer sides of the light extraction structure 7, and the distance between the respective reflective electrodes was set to be 2 μm. In contrast, in a region between the reflective electrode 2R corresponding to the red subpixel belonging to the pixel 8b and the reflective electrode 2B corresponding to the blue subpixel belonging to the pixel 8a, the end of each light extraction structure 7 and the end of each reflective electrode are formed so as to be matched with each other.

The distance between the respective ends was set to be larger than that between the reflective electrodes corresponding to the respective subpixels within the pixel, and in the present example, was set to be 15 μm.

The film thickness d of the transparent layer 9 (transparent electrode 11, organic compound layer 4, transparent electrode 10, high-refractive-index transparent layer 6) in the present example was 1.3 μm in total (ITO film+organic compound layer+IZO film+high-refractive-index transparent layer=50 nm+200 nm+50 nm+1.0 μm). The angle θ was 60°. Thus, tan6 is 1.73 and the distance W is 15 μm, that is, W/2d=5.8, and hence, the relationship of tan θ<W/2d is satisfied.

In order to check the degree of blur in the display apparatus thus produced, a human image was displayed against the background of the blue sky, and an emission color of a contour portion in a white site such as the skin was checked. In the contour portion of the human in the display image obtained in the present example, no change in an emission color derived from blur was found.

### Comparative Example 1

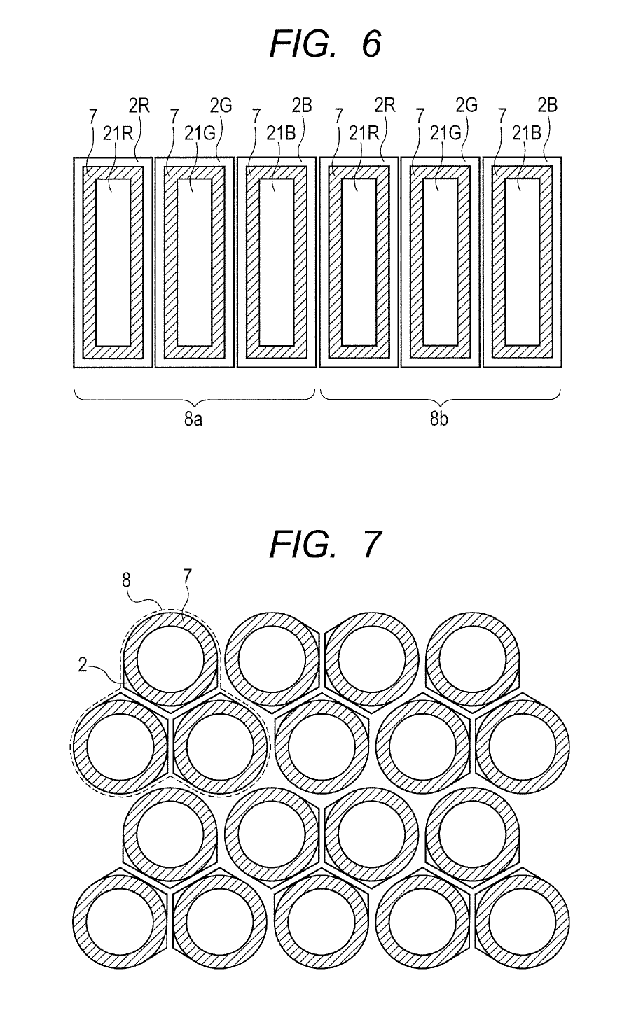

As illustrated in FIG. 6, a display apparatus was produced in the same way as in Example 1 with the exception that all the ends of reflective electrodes were disposed up to outer sides of the outer circumferences of the light extraction structures 7, and all the distances between the reflective electrodes were set to be 2 μm.

In order to check the degree of blur in the organic EL display apparatus thus produced, a human image was displayed against the background of the blue sky, and an emission color of a contour portion in a white site such as the skin was checked. In the contour portion of the human in the display image obtained in the present example, a change in an emission color derived from blur was found, and a bluish violet blur was visually recognized in the contour portion.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-214141, filed Sep. 29, 2011, which is hereby incorporated by reference herein in its entirety.

What is claimed is:

1. A display apparatus, comprising a plurality of pixels each comprising a plurality of subpixels having different emission colors,
each of the plurality of subpixels comprising an organic electroluminescence device which comprises:
a first electrode that is a reflective electrode;
a second electrode; and
an organic compound layer comprising an emission layer disposed between the first electrode and the second electrode,
wherein the display apparatus further comprises a transparent layer having a refractive index higher than a refractive index of the organic compound layer, the transparent layer being disposed on a light exit side of the organic electroluminescence device,
wherein the transparent layer comprises a light extraction structure provided on an outer side of each of the plurality of subpixels, and
wherein a distance between the first electrodes of subpixels closest to each other, which are respectively included in adjacent two of the plurality of pixels, is larger than a distance between the first electrodes of adjacent two of the plurality of subpixels within each of the plurality of pixels.

2. The display apparatus according to claim 1, wherein a relationship: tan θ<W/2d is satisfied, where d represents a distance from the first electrode to a light exit surface of the transparent layer, W represents a distance between the first electrodes of the subpixels closest to each other, which are respectively included in the adjacent two of the plurality of pixels, and e represents an angle formed by a normal to a substrate and a direction in which a maximum of radiation intensity appears, excluding a direction of the normal to the substrate, in a radiation intensity distribution of the organic electroluminescence device in the transparent layer from the first electrode to the light exit surface of the transparent layer.

3. The display apparatus according to claim 1, wherein the light extraction structures provided on outer sides of the respective plurality of subpixels within the each of the plurality of pixels are in contact with each other.

4. The display apparatus according to claim 1, wherein the light extraction structure has a protruding shape on the light exit side.

5. The display apparatus according to claim 1,
wherein a cross-section of the light extraction structure is a triangle, and
wherein an apex angle of the triangle is 120° or more and 140° or less.

6. The display apparatus according to claim 5, wherein the triangle is an isosceles triangle.

7. The display apparatus according to claim 1, wherein the light extraction structure is formed so as to surround each of the plurality of subpixels.

8. The display apparatus according to claim 1, wherein the light extraction structure is formed of a plurality of conical structures.

9. The display apparatus according to claim 1, wherein the light extraction structure is formed of a ring-shaped structure in which conical structures are integrated in a loop shape.

10. The display apparatus according to claim 1, wherein an end of the first electrode of the organic electroluminescence device of corresponding one of the plurality of subpixels and an outermost circumference of the light extraction structure provided on the outer side of the corresponding one of the plurality of subpixels are matched with each other in a plane.

11. The display apparatus according to claim 1, wherein a light transmittance of the transparent layer is at least 85% in a visible light region.

12. The display apparatus according to claim 1, wherein the transparent layer includes at least one of silicon nitride, titanium oxide, zirconium oxide, and zinc oxide.

13. The display apparatus according to claim 1, wherein the transparent layer has a film thickness of 0.5 μm or more and 10.0 μm or less.
